(19) United States
(12) Patent Application Publication
(10) Pub. No.: US 2004/0187291 A1
(43) Pub. Date: Sep. 30, 2004

(54) Method for changing fixtures used to position a plurality of different workpieces on an assembly line

(76) Inventor: Richard Syrek, Chester Springs, PA (US)

Correspondence Address: SAMUEL W. APICELLI, DUANE MORRIS LLP, 305 NORTH FRONT STREET, P.O. BOX 1003, HARRISBURG, PA, 17108-1003, US

(21) Appl. No.: 10/405,011

(22) Filed: Mar. 31, 2003

(51) Int. Cl. B23Q 7/00

(52) U.S. Cl. 29/559

(57) ABSTRACT

The a modular system for locating and clamping a workpiece in space is provided that includes positioning blade including a riser mount having a plurality of first mounting-bores and a plurality of first positioning-bores. A fixture-mount is provided on the blade that includes a plurality of second mounting-bores and a plurality of second positioning-bores. The first positioning-bores have a predetermined positional relationship to the second positioning-bores. A locator arm is also provided on the blade, and has a plurality of third positioning-bores where the third positioning-bores comprise a predetermined position relative to the first positioning-bores and the second positioning-bores. A system for positioning and clamping a workpiece is also provided that includes in combination the foregoing positioning blade mounted on structure for elevating the workpiece, e.g., a riser, and structure for clamping the workpiece. A kit for forming a variety of fixtures for positioning and clamping a workpiece is also provided that includes a plurality of position determining modules where each module includes a positioning blade having a different set of positional locations for its positioning-bores.

### FIELD OF THE INVENTION

The present invention generally relates to methods for workpiece fixturing and positioning, and more particularly to a method for changing between a plurality of fixtures used to position multiple different workpieces, successively, without significant retooling of a production line.

### BACKGROUND OF THE INVENTION

Workpiece positioning and clamping methods and fixtures are well known in the art. For example, U.S. Pat. No. 3,968,558, issued to Sekine, et al. discloses apparatus and methods for the assemblage of an automobile body structure from a floor panel and side panels. Sekine et al., suggest that it is a usual practice to have the side panels vertically conveyed by a hoist into predetermined positions relative to an assembling jig mechanism. Once the side panels are moved into predetermined positions, they are removed from the hoist and mounted and clamped on the jig mechanism. The positions of the side panels relative to the jig mechanism are then accurately adjusted by manually moving the side panels into predetermined positions in which positioning pins, provided in the jig mechanism, are in strict alignment with positioning openings formed in the side panels.

Automating the assemblage of the automobile body structure is known to be extraordinarily difficult, since prior art jig mechanisms are arranged to mainly serve the purpose of accurately holding various portions of the automobile, e.g., side panels, in position. These prior art fixtures are very often composed of a great number of component parts, most of which are movable. This has made changing between fixtures to accommodate model changes during production difficult and expensive. A quick, repeatable, and accurate methodology for change-over between different positioning fixtures would not only reduce manufacturing costs, but would also yield finished parts that are more consistently formed than previously observed in the art.

U.S. Pat. No. 6,364,302, issued to Ausilio, discloses a modular system for locating and clamping a workpiece in space that includes a plurality of positioning blades having a riser mount with a plurality of first mounting-bores and a plurality of first positioning-bores. A fixture-mount is provided on the blade that includes a plurality of second mounting-bores and a plurality of second positioning-bores. The first positioning-bores have a predetermined positional relationship to the second positioning-bores. A locator arm is also provided on the blade, and has a plurality of third positioning-bores where the third positioning-bores comprise a predetermined position relative to the first positioning-bores and the second positioning-bores. Although Ausilio discloses an apparatus for accurately positioning a workpiece, it does not adequately address the need for a change-over methodology.

None of the prior art discloses an adequate methodology for changing between fixtures to accommodate model changes in production and to provide improved, and more consistently formed and assembled parts and workpieces.

### SUMMARY OF THE INVENTION

A method is provided for changing fixtures used to position a workpiece so that manufacturing operations may be performed upon different workpieces supported by the same fixture. A first workpiece-positioning blade is provided that is releasably mounted to a portion of a support at a known location, and comprises a plurality of first positioning-bores and at least a plurality of second positioning-bores defined therethrough, where the first positioning-bores comprise a predetermined positional relationship to the second positioning-bores. At least a second workpiece-positioning blade is provided that is releasably mountable to the portion of the support at the known location, and comprises a plurality of third positioning-bores and at least a plurality of fourth positioning-bores defined therethrough, where the plurality of third positioning-bores comprise a predetermined positional relationship to the at least a plurality of forth positioning-bores that is incrementally different from the predetermined positional relationship between the first plurality of positioning-bores and the at least a plurality of second positioning-bores of the first workpiece-positioning blade. To facilitate production run change-over according to the method of the invention, at least a second workpiece-positioning blade is exchanged for the first workpiece-positioning blade on the support.

As a result of practicing the foregoing method, a plurality of workpieces may be formed that comprise portions of the same or different machines or models of machine, e.g., automobiles, white goods appliances, aircraft, etc. This plurality of workpieces exhibit closer tolerance match than has heretofore been achievable.

The present method for performing manufacturing operations upon more than one workpiece successively supported by a fixture may also include providing a first workpiece-positioning blade that is releasably mounted to a portion of a support at a known location. The first workpiece-positioning blade comprises a plurality of first positioning-bores and at least a plurality of second positioning-bores defined therethrough, where the first positioning-bores comprise a predetermined positional relationship to the second positioning-bores. A first workpiece is releasably supported upon the support fixture so that the first plurality of positioning-bores and the at least a plurality of second positioning-bores comprise a known relationship to portions of the first workpiece. At least one manufacturing operation is performed upon the first workpiece. The first workpiece is then removed from the support fixture, and the first workpiece-positioning blade is exchanged for at least a second workpiece-positioning blade. The second workpiece-positioning blade is releasably mountable to a portion of the support at a known location, and comprises a plurality of third positioning-bores and at least a plurality of fourth positioning-bores defined therethrough, where the plurality of third positioning-bores comprise a predetermined positional relationship to the at least a plurality of forth positioning-bores that is incrementally different from the predetermined positional relationship between the first plurality of positioning-bores and the at least a plurality of second positioning-bores of the first workpiece-positioning blade. A second workpiece is releasably supported upon the support fixture so that the third plurality of positioning-bores and the at least a plurality of forth positioning-bores comprises a known relationship to portions of the second workpiece. At least one manufacturing operation is then performed upon the second workpiece.

Here again as a result of practicing the foregoing method, a plurality of workpieces may be formed that comprise portions of the same or different machines or models of machine, e.g., automobiles, white goods appliances, aircraft, etc.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view, partially in phantom, of a modular system and fixture for positioning and clamping a workpiece having a workpiece-positioning blade mounted on a riser with a clamping assembly assembled to a portion of the workpiece-positioning blade that may be used in connection with the method of the present invention;

FIG. 2 is a perspective view of a modular system and fixture for positioning and clamping a workpiece that may be used in connection with the method of the present invention;

FIG. 3 is a flow chart of one operating sequence for the method of the present invention;

FIG. 4 is a perspective view of a workpiece-positioning blade formed that may be used in connection with the method of the present invention;

FIG. 5 is a perspective view of another workpiece-positioning blade including a transition portion that may be used in connection with the method of the present invention;

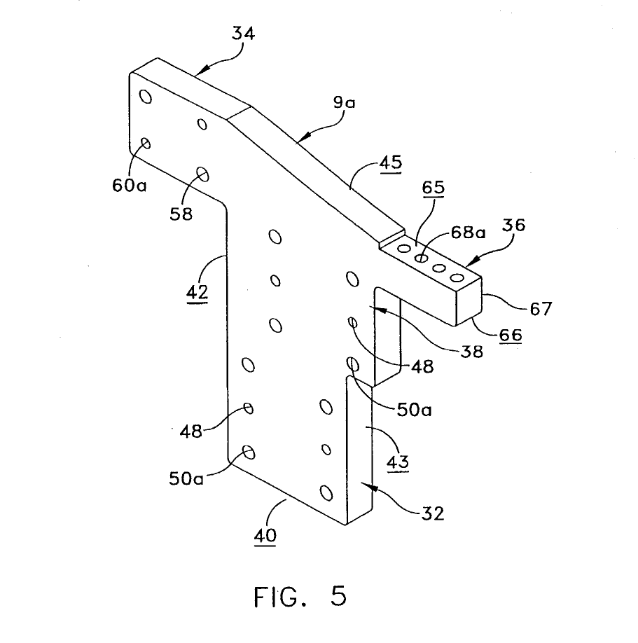

FIG. 6 is a perspective view, partially in phantom, similar to FIG. 1, but including a different workpiece.

### DETAILED DESCRIPTION OF THE PREFERRED EMBODIMENT

This description of preferred embodiments is intended to be read in connection with the accompanying drawings, which are to be considered part of the entire written description of this invention. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, couplings and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

The present invention provides a method for changing fixtures in an assembly line so as to position numerous different workpieces 5, e.g., various portions of an automobile, body or chassis, airplane body, wing, or chassis, white good appliance body or chassis, or the like, in succession so that manufacturing operations may be performed upon them. When practicing the present method it is advantageous to employ a fixturing apparatus for positioning a workpiece as disclosed, e.g., in U.S. Pat. No. 6,364,302, issued to Ausilio, which patent is hereby incorporated herein by reference. Such a modular fixturing apparatus comprises a support-riser 7 and a workpiece-positioning blade 9. This combination of structures may then support a positioning pin or a clamp assembly 11 according to the needs of the manufacturing operations to be performed on workpiece 5.

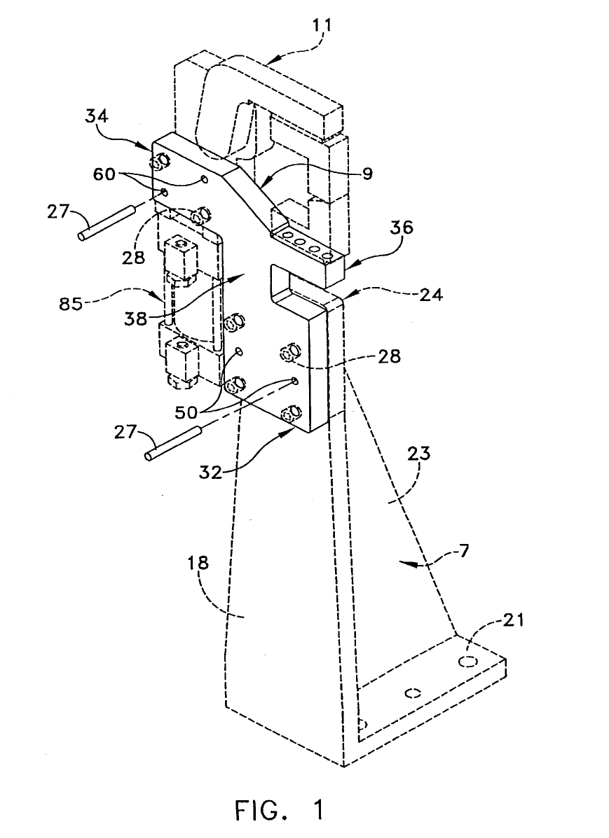

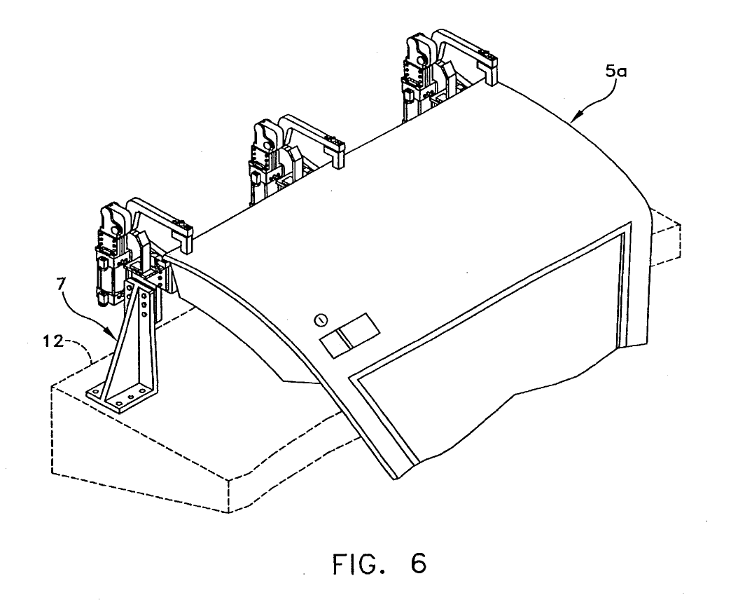

Referring to FIGS. 1, 2, and 6, support-riser 7 includes a mounting plate 18 and a seat plate 21, with a stiffening support 23 fastened between them to add to the rigidity and ability of support-riser 7 to sustain significant loads. Workpiece-positioning blade 9 is mounted to a top portion 24 of each support-riser 7. A plurality of positioning-bores and mounting-bores (not shown) are often defined in top portion 24 of each support-riser 7. The positioning-bores are accurately sized and shaped, and selectively and precisely located in top portion 24 for operatively locating workpiece-positioning blade 9 on support-riser 7, via dowel pins 27. Conventional fasteners, e.g., bolts 28 or the like, are positioned through the mounting-bores so as to fasten workpiece-positioning blade 9 to top portion 24 of support-riser 7. The positioning-bores of support-riser 7 may be located at varying fixed distances from the bottom surface of seat plate 21, e.g., between one-hundred and five-hundred millimeters, etc., in about five millimeter to about thirty-five millimeter increments, more or less.

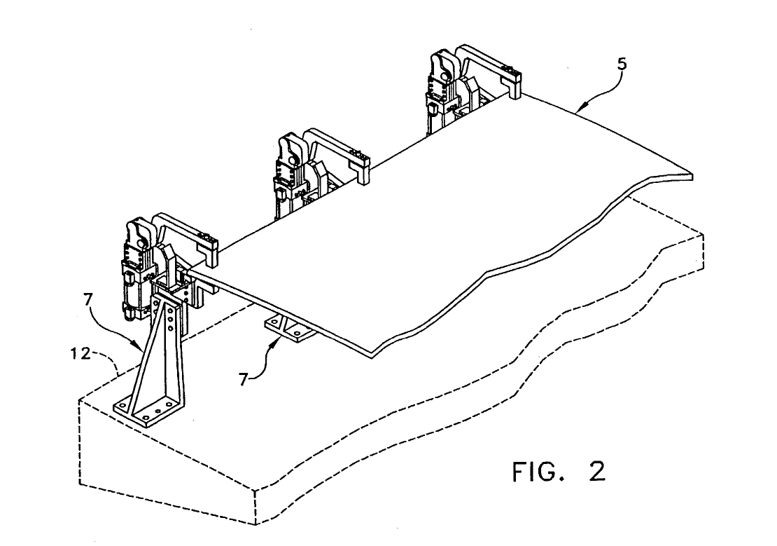

A plurality of support-risers 7 are often mounted on a platform 12 in a predetermined matrix of holes having an adequate distance from each other such that support risers 7 can be positioned to accommodate virtually any size or shape workpiece 5 (FIG. 2). The dimensions and general shape of support-risers 7 are subject to industry agreed upon standards, with specific tolerance allowances, which would be known to those skilled in the art.

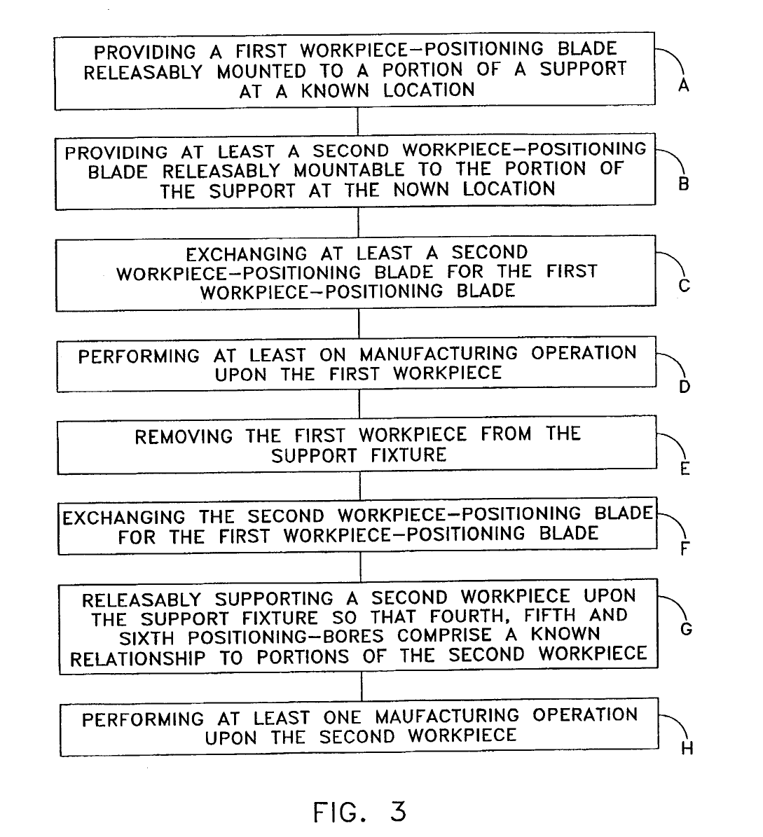

Referring to FIG. 3, one preferred embodiment of the method of the invention may be performed, starting with a first step A, by providing a first workpiece-positioning blade 9 that is releasably mounted to a portion of a support-riser 7 at a known location in space. First workpiece-positioning blade 9 includes first positioning-bores and at least a plurality of second positioning-bores defined therethrough, where the first positioning-bores comprise a predetermined positional relationship to the second positioning-bores.

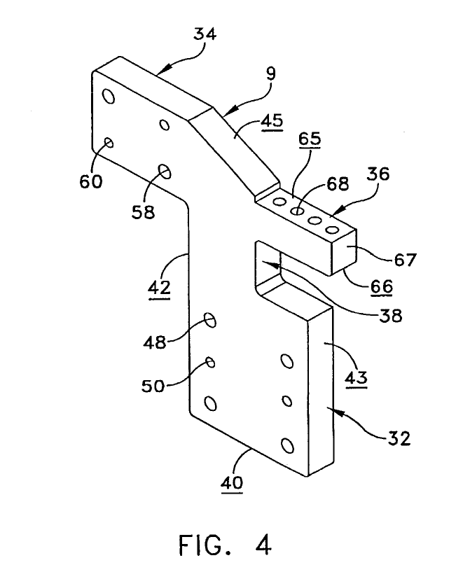

Referring to FIG. 4, workpiece-positioning blade 9 often comprises a metal plate that includes a riser mount 32 and at least one of a fixture-mount 34 and a locator arm 36. Riser mount 32 includes a bottom edge surface 40, side edge surfaces 42,43, a top edge surface 45, multiple mounting-bores 48, and multiple positioning-bores 50. When mounted to support-riser 7, workpiece-positioning blade 9 is often oriented such that riser mount 32 is arranged below locator arm 36 and fixture-mount 34. A transition portion 38 often interconnects riser mount 32 with fixture-mount 34 and locator arm 36. Mounting-bores 48 are sized and shaped to receive fasteners, such as bolts 28 or the like.

Positioning-bores 50 are accurately sized and shaped, and selectively and precisely located on riser mount 32 so as to operatively receive dowel pins 27 (FIG. 1), and thereby to selectively and precisely position workpiece-positioning blade 9 on support-riser 7. Advantageously, positioning-bores 50 may be located at varying, predetermined fixed distances from bottom edge surface 40. According to the method of the present invention, a plurality of workpiece-positioning blades 9 are provided, each having positioning-bores 50 located at different predetermined positions along the length of riser mount 32 or transition portion 38, e.g., in ten, fifteen or twenty millimeter increments as measured from bottom edge surface 40.

Fixture-mount 34 of workpiece-positioning blades 9 projects outwardly from a top portion of side edge surface 42, and includes mounting-bores 58 and positioning-bores 60. Mounting-bores 58 are sized and shaped to receive fasteners, such as bolts 28. Positioning-bores 60 are accurately sized and shaped, and selectively and precisely located on fixture-mount 34 so as to operatively receive dowel pins 27, and thereby to selectively and precisely position positioning pin or clamp assembly 11 relative to support-riser 7. Positioning-bores 60 are often arranged within the parallel rows of mounting-bores 58. Here again, positioning-bores 60 are located at varying, predetermined fixed distances from positioning-bores 50, so as to establish their true position relative to support-riser 7.

A plurality of workpiece-positioning blades 9 are often utilized with the method of the present invention having positioning-bores 60 at different predetermined positions along the length of fixture-mount 34, e.g., in ten, fifteen, and twenty millimeter increments. If a locator arm 36 is provided, it projects outwardly relative to a top portion of side edge surface 43, and includes a top surface 65, a bottom surface 66, and a front face 67. A plurality of longitudinally extending through-bores 68 are defined between top surface 65 and bottom surface 66, and are sized and shaped to receive a releasable fastener, such as a bolt or the like. Through-bores 68 are sized, shaped, and selectively located on top surface 65 of locator arm 36 so as to operatively position a portion of positioning pin or clamp assembly 11. Through-bores 68 are located at varying, predetermined fixed distances from positioning-bores 60. Positioning-bores 50 and 60 of workpiece-positioning blade 9 may be located at varying fixed distances from the bottom surface of seat plate 21, e.g., three-hundred, three-hundred and twenty, four-hundred and thirty, five-hundred and forty millimeters, etc., by simply adjusting riser mount 32 upwardly or downwardly relative to top portion 24 of support-riser 7.

Referring again to FIG. 3, and continuing to step B of the present method, at least a second workpiece-positioning blade 9a is provided that is releasably mountable to the portion of support-riser 7 at the known location. Second workpiece-positioning blade 9a is formed in a substantially similar manner of workpiece-positioning blade 9, comprises at least a plurality of third positioning-bores 50a and at least a plurality of fourth positioning-bores 60a defined therethrough. Plurality of third positioning-bores 50a comprise a predetermined positional relationship to the at least a plurality of forth positioning-bores 60a that is incrementally different from the predetermined positional relationship between the first plurality of positioning-bores 50 and the at least a plurality of second positioning-bores 60 of first workpiece-positioning blade 9. It will be understood that first workpiece-positioning blade 9 or second workpiece-positioning blade 9a may include a variety of patterns of fourth positioning-bores 68a, fifth positioning bores, sixth positioning-bores, etc.

In a step C of the present method, second workpiece-positioning blade 9a is exchanged for first workpiece-positioning blade 9 on support-riser 7. A first workpiece 5 is then releasably supported upon first workpiece-positioning blade 9 on support-riser 7 so that first plurality of positioning-bores 50 and a plurality of second positioning-bores 60 comprise a known relationship to portions of this first workpiece. Once in this position, at least one manufacturing operation may be performed on workpieces in step D. In a further step E, first workpiece 5 is removed from support-riser 7. In a step F, first workpiece-positioning blade 9 is disassembled from support-riser 7 and exchanged for second workpiece-positioning blade 9a which is releasably mounted on support-riser 7 at a known location. In a step G, a second workpiece 5a is releasably supported upon support-riser 7 and workpiece-positioning blade 9a so that third plurality of positioning-bores 50a and plurality of forth positioning-bores 60a comprise a known relationship to portions of second workpiece 5a. In a further step H, at least one manufacturing operation is performed upon second workpiece 5a.

As a result of practicing the foregoing methodology, a plurality of different workpieces may be formed that comprise portions of the same or different machines or models of machine, e.g., automobiles, white goods appliances, aircraft, etc. This plurality of different workpieces exhibit closer tolerance match than has been achievable.

It is to be understood that the present invention is by no means limited only to the particular constructions herein disclosed and shown in the drawings, but also comprises any modifications or equivalents within the scope of the claims.

What is claimed is:

1. A method for changing fixtures used to position a workpiece so that manufacturing operations may be performed upon different workpieces supported by the same fixture comprising:
providing a first workpiece-positioning blade (i) releasably mounted to a portion of a support at a known location, and (ii) comprising a plurality of first positioning-bores and at least a plurality of second positioning-bores defined therethrough, wherein said first positioning-bores comprise a predetermined positional relationship to said second positioning-bores;
providing at least a second workpiece-positioning blade (i) releasably mountable to said portion of said support at said known location, and (ii) comprising a plurality of third positioning-bores and at least a plurality of fourth positioning-bores defined therethrough, wherein said plurality of third positioning-bores comprise a predetermined positional relationship to said at least a plurality of forth positioning-bores that is incrementally different from said predetermined positional relationship between said first plurality of positioning-bores and said at least a plurality of second positioning-bores of said first workpiece-positioning blade; and
exchanging said at least a second workpiece-positioning blade for said first workpiece-positioning blade on said support.

2. A plurality of workpieces formed according to the method of claim 1.

3. A plurality of workpieces according to claim 2 wherein said workpieces comprise portions of different machines.

4. A plurality of workpieces according to claim 2 wherein said workpieces comprise portions of the same machine.

5. A plurality of workpieces according to claim 2 wherein said workpieces comprise portions of the same model of machine.

6. A plurality of workpieces according to claim 2 wherein said workpieces comprise portions of different models of machine.

7. A plurality of workpieces according to claim 2 wherein said workpieces comprise portions of different automobiles.

8. A plurality of workpieces according to claim 2 wherein said workpieces comprise portions of the same automobile.

9. A plurality of workpieces according to claim 2 wherein said workpieces comprise portions of the same model of automobile.

10. A plurality of workpieces according to claim 2 wherein said workpieces comprise portions of different models of automobile.

11. A method for performing manufacturing operations upon more than one workpieces successively supported by a fixture comprising:
providing a first workpiece-positioning blade (i) releasably mounted to a portion of a support fixture at a known location, and (ii) comprising a plurality of first positioning-bores and at least a plurality of second positioning-bores defined therethrough, wherein said first positioning-bores comprise a predetermined positional relationship to said second positioning-bores;
releasably supporting a first workpiece upon said support fixture so that said first plurality of positioning-bores and said at least a plurality of second positioning-bores comprises a known relationship to portions of said first workpiece;
performing at least one manufacturing operation upon said first workpiece;
removing said first workpiece from said support fixture;
providing at least a second workpiece-positioning blade (i) releasably mountable to said portion of said support fixture at said known location, and (ii) comprising a plurality of third positioning-bores and at least a plurality of fourth positioning-bores defined therethrough, wherein said plurality of third positioning-bores comprise a predetermined positional relationship to said at least a plurality of forth positioning-bores that is incrementally different from said predetermined positional relationship between said first plurality of positioning-bores and said at least a plurality of second positioning-bores of said first workpiece-positioning blade; and
exchanging said at least a second workpiece-positioning blade for said first workpiece-positioning blade;
releasably supporting a second workpiece upon said support fixture so that said third plurality of positioning-bores and said at least a plurality of forth positioning-bores comprises a known relationship to portions of said second workpiece; and
performing at least one manufacturing operation upon said second workpiece.

12. A plurality of workpieces formed according to the method of claim 11.

13. A plurality of workpieces according to claim 12 wherein said workpieces comprise portions of different machines.

14. A plurality of workpieces according to claim 12 wherein said workpieces comprise portions of the same machine.

15. A plurality of workpieces according to claim 12 wherein said workpieces comprise portions of the same model of machine.

16. A plurality of workpieces according to claim 12 wherein said workpieces comprise portions of different models of machine.

17. A plurality of workpieces according to claim 12 wherein said workpieces comprise portions of different automobiles.

18. A plurality of workpieces according to claim 12 wherein said workpieces comprise portions of the same automobile.

19. A plurality of workpieces according to claim 12 wherein said workpieces comprise portions of the same model of automobile.

20. A plurality of workpieces according to claim 12 wherein said workpieces comprise portions of different models of automobile.

21. A method for changing fixtures used to position a workpiece so that manufacturing operations may be performed upon different workpieces supported by the same fixture comprising:
providing a first workpiece-positioning blade (i) releasably mounted to a portion of a support at a known location, and (ii) comprising a pattern of first positioning-bores, a pattern of second positioning-bore, and a pattern of third positioning-bores defined therethrough, wherein said first, second, and third positioning-bores comprise a predetermined positional relationship to one another;
providing at least a second workpiece-positioning blade (i) releasably mountable to said portion of said support at said known location, and (ii) comprising a pattern of fourth positioning-bores, a pattern of fifth positioning bores, and a pattern of sixth positioning-bores defined therethrough, wherein said fourth, fifth, and sixth positioning-bores comprise a predetermined positional relationship to one another that is incrementally different from said predetermined positional relationship between said first, second, and third positioning-bores of said first workpiece-positioning blade; and
exchanging said at least a second workpiece-positioning blade for said first workpiece-positioning blade on said support.

22. A method for performing manufacturing operations upon more than one workpieces successively supported by a fixture comprising:
providing a first workpiece-positioning blade (i) releasably mounted to a portion of a support fixture at a known location, and (ii) comprising a pattern of first positioning-bores, a pattern of second positioning-bore, and a pattern of third positioning-bores defined therethrough, wherein said first, second, and third positioning-bores comprise a predetermined positional relationship to one another;
releasably supporting a first workpiece upon said support fixture so that said at least one first, second, and third positioning-bores comprise a known relationship to portions of said first workpiece;
performing at least one manufacturing operation upon said first workpiece;
removing said first workpiece from said support fixture;
providing a second workpiece-positioning blade (i) releasably mountable to said portion of said support fixture at said known location, and (ii) comprising a pattern of fourth positioning-bores, a pattern of fifth positioning bores, and a pattern of sixth positioning-bores defined therethrough, wherein said fourth, fifth, and sixth positioning-bores comprise a predetermined positional relationship to one another that is incrementally different from said predetermined positional relationship between said first, second, and third positioning-bores of said first workpiece-positioning blade;
exchanging said second workpiece-positioning blade for said first workpiece-positioning blade;
releasably supporting a second workpiece upon said support fixture so that said fourth, fifth, and sixth positioning-bores comprise a known relationship to portions of said second workpiece; and
performing at least one manufacturing operation upon said second workpiece.

23. A method for changing fixtures used to position a workpiece so that manufacturing operations may be performed upon different workpieces supported by the same fixture comprising:
providing a first workpiece-positioning blade (i) releasably mounted to a portion of a support at a known location, and (ii) comprising multiple patterns of positioning-bores, defined therethrough, wherein said positioning-bores comprise a predetermined positional relationship to one another;
providing at least a second workpiece-positioning blade (i) releasably mountable to said portion of said support at said known location, and (ii) comprising multiple patterns of positioning-bores defined therethrough, wherein said positioning-bores comprise a predetermined positional relationship to one another that is incrementally different from said predetermined positional relationship between said positioning-bores of said first workpiece-positioning blade; and
exchanging said at least a second workpiece-positioning blade for said first workpiece-positioning blade on said support.

24. A plurality of workpieces formed according to the method of claim 23.

25. A plurality of workpieces according to claim 24 wherein said workpieces comprise portions of different machines.

26. A plurality of workpieces according to claim 24 wherein said workpieces comprise portions of the same machine.

27. A plurality of workpieces according to claim 24 wherein said workpieces comprise portions of the same model of machine.

28. A plurality of workpieces according to claim 24 wherein said workpieces comprise portions of different models of machine.

29. A plurality of workpieces according to claim 24 wherein said workpieces comprise portions of different automobiles.

30. A plurality of workpieces according to claim 24 wherein said workpieces comprise portions of the same automobile.

31. A plurality of workpieces according to claim 24 wherein said workpieces comprise portions of the same model of automobile.

32. A plurality of workpieces according to claim 24 wherein said workpieces comprise portions of different models of automobile.

33. A method for performing manufacturing operations upon more than one workpieces successively supported by a fixture comprising:
providing a first workpiece-positioning blade (i) releasably mounted to a portion of a support fixture at a known location, and (ii) comprising multiple patterns of positioning-bores, defined therethrough, wherein said positioning-bores comprise a predetermined positional relationship to one another;
releasably supporting a first workpiece upon said support fixture so that said at positioning-bores comprise a known relationship to portions of said first workpiece;
performing at least one manufacturing operation upon said first workpiece;
removing said first workpiece from said support fixture;
providing a second workpiece-positioning blade (i) releasably mountable to said portion of said support fixture at said known location, and (ii) comprising multiple patterns of positioning-bores defined therethrough, wherein said positioning-bores comprise a predetermined positional relationship to one another that is incrementally different from said predetermined positional relationship between said multiple patterns of positioning-bores of said first workpiece-positioning blade;
exchanging said second workpiece-positioning blade for said first workpiece-positioning blade;
releasably supporting a second workpiece upon said support fixture so that said multiple patterns of positioning-bores comprise a known relationship to portions of said second workpiece; and
performing at least one manufacturing operation upon said second workpiece.
